(19) United States
(12) Patent Application Publication
(10) Pub. No.: US 2022/0169237 A1
(43) Pub. Date: Jun. 2, 2022

(54) ELECTRIFIED POWERTRAIN WITH MAXIMUM PERFORMANCE MODE CONTROL STRATEGY USING EXTENDED INVERTER LIMIT

(71) Applicant: GM GLOBAL TECHNOLOGY OPERATIONS LLC, Detroit, MI (US)

(72) Inventors: Yiran Hu, Shelby Township, MI (US); Brent S. Gagas, Ferndale, MI (US); Kee Y. Kim, Ann Arbor, MI (US); James S. Creehan, Dexter, MI (US); Brian A. Welchko, Oakland, MI (US); Patrick E. Frost, Berkley, MI (US)

(73) Assignee: GM GLOBAL TECHNOLOGY OPERATIONS LLC, Detroit, MI (US)

(21) Appl. No.: 17/109,342

(22) Filed: Dec. 2, 2020

(51) Int. Cl. B60W 20/15; B60K 1/00; B60L 15/20; B60K 26/02; B60K 1/04; B60W 30/182

(52) U.S. Cl. CPC B60W 20/15; B60K 1/00; B60L 15/20; B60L 2210/40; B60K 1/04; B60W 30/182; B60K 26/02

(57) ABSTRACT

A method controls an electrified powertrain having an electric traction motor and a traction power inverter module (TPIM). A controller determines a current component capability and use case of the electrified powertrain. In response to the current component capability being less than a capability threshold and the use case matching a predetermined approved use case, the controller determines whether a predetermined margin exists in the component capability for operating the electrified powertrain in a maximum performance mode (MPM) for a full duration of a boosted driving maneuver. When the predetermined margin exists, the controller temporarily applies an extended inverter limit (EIL) of the TPIM to enable the MPM. The EIL allows operation of the traction motor to occur above default torque and speed operating limits for the full duration of the boosted driving maneuver. MPM/EIL availability is communicated to the operator.

### INTRODUCTION

The present disclosure relates to systems and methods for optimizing the electric drive performance of a hybrid electric, battery electric, or extended-range electric vehicle, as well as other mobile platforms having an electrified powertrain. As appreciated in the art, an electrified powertrain is “electrified” in the sense of having a high-voltage bus powering operation of one or more rotary electric machines. For example, a hybrid electric motor vehicle includes multiple different prime movers, typically an internal combustion engine and one or more electric traction motors. Output torque from the engine and/or the traction motor(s) ultimately powers one or more drive axles or road wheels during different drive modes. The relative torque contribution from the various prime movers is selected in real-time based by an onboard controller based on a driver-requested torque and a myriad of other performance parameters. In contrast, a battery electric vehicle is propelled solely by motor torque from the energized traction motor(s). An extended-range electric vehicle (EREV) includes a small engine that may be decoupled from the vehicle's drive line. In the EREV configuration, therefore, the engine is used as a standby electric generator for extending the vehicle's electric operating range, as opposed to powering the vehicle as a prime mover.

When an electric traction motor is as part of an electrified powertrain, the electric traction motor is frequently configured as polyphase/alternating current (AC) machine. Therefore, a power inverter is disposed between a wound stator of the traction motor and an onboard voltage supply, with the latter typically embodied as a high-voltage rechargeable direct current (DC) propulsion battery pack. Switching state control of individual semiconductor switches arranged within the TPIM converts a DC input voltage from the battery pack into a polyphase/AC output voltage. The AC output voltage from the inverter sequentially energizes the stator's field windings and ultimately imparts rotation to a machine rotor. Loading of the traction motor and inverter is carefully controlled and limited according to a calibrated set of thermal and other performance capability limits. Accordingly, an electric traction motor may be situationally de-rated or load-reduced in real-time by an onboard controller to protect the inverter, traction motor, and other sensitive components of the electrified powertrain.

### SUMMARY

The present disclosure pertains to real-time operational control of an electrified powertrain of a motor vehicle or other mobile platform having at least one electric traction motor connected to and driven by a respective power inverter, the latter of which is referred to hereinafter as a traction power inverter module (TPIM). The method described herein situationally and temporarily enables entry into an enhanced “maximum performance” mode, abbreviated herein as “MPM” for simplicity. This occurs via selective application of an extended inverter limit (“EIL”) as described below, with EIL temporarily expanding upon more limited default/normal inverter limit (“NIL”).

As entry into MPM is restricted by the controller to certain forward-looking performance conditions in which MPM could be reliably implemented for a full duration of a boosted driving maneuver, i.e., one in which EIL is temporarily applied in lieu of the default NIL noted above, a present MPM availability status is communicated in an intuitive manner to the operator aboard the vehicle to help manage the operator's performance expectations. In other words, the operator is informed when MPM will be available for the duration of the boosted driving maneuver, e.g., a 0-60 MPH acceleration maneuver. Additionally, for multi-axle/multi-motor embodiments of the present electrified powertrain, aspects of the disclosure apply a costing function or other torque arbitration strategy to balance thermal loading and wear of the various electric machines/TPIMs over time, while still providing the expected boosted level of performance provided by operation in MPM.

As is well understood in the art, power inverter limits are informed by short-term and long-term durability effects on sensitive power electronic hardware of an electrified powertrain, principally the switching junctions of the tiny semiconductor switches used to construct each TPIM. Such limits are used to trigger automatic de-rating actions via modulation of the duty cycle used to control the ON/OFF conducting states of such switches. De-rating actions would ordinarily be performed by the controller when inverter/motor temperatures and/or other relevant control values exceed calibrated limits. EIL within the scope of the present disclosure is therefore “extended” in the sense of increasing or expanding the above-noted NIL/default inverter limits or operating ranges normally enforced outside of occasional operation in MPM.

In an exemplary embodiment, a method for controlling an electrified powertrain having an electric traction motor and a TPIM includes determining, via a controller, each of a current component capability and a current use case of the electrified powertrain. In response to the current component capability being less than a calibrated capability threshold and the current use case matching a predetermined approved use case, the method includes determining whether a predetermined margin exists in the current component capability for operating the electrified powertrain in the MPM for a full duration of a boosted driving maneuver.

The method also includes receiving input signals indicative of a requested torque, the requested torque being a desired output torque level of the electric traction motor. In response to the input signals when the predetermined margin exists, the method additionally includes temporarily applying an EIL of the TPIM, via the controller, to thereby enable the MPM. Application of the EIL allows operation of the electric traction motor to occur above default torque and speed operating limits for the full duration of the boosted driving maneuver.

The method may include communicating an availability status of the MPM to an operator of the electrified powertrain via an indicator device prior to applying the EIL, with the availability status being indicative of an availability of the MPM for the full duration of the boosted driving maneuver.

Some embodiments include disabling the EIL via the controller in response to the current component capability not exceeding the calibrated capability threshold or the current use case not matching the predetermined approved use case. The predetermined approved use case may be stored in memory of the controller, in which case determining the current use case of the electrified powertrain includes comparing a present use case of the electrified powertrain to the predetermined use case.

The electrified powertrain may include an accelerator pedal, with the input signals including an amount of pedal travel of the accelerator pedal, and with the predetermined approved use case being a wide-open throttle or wide-open pedal condition of the accelerator pedal indicative of a predetermined acceleration event. The predetermined approved use case in some embodiments of the method is an acceleration-from-a-standstill maneuver and/or a high-speed passing maneuver.

The method may include selectively disabling the EIL in response to an active traction control state.

The indicator device may be optionally configured as a digital gauge. In such a case, the controller communicates the availability status of the MPM as part of the method by illuminating one or more light-emitting diodes of the digital gauge with a color indicative of the availability status.

The electric traction motor in some configurations includes a plurality of electric traction motors, the TPIM includes a plurality of TPIMs each connected to a respective one of the electric traction motors, and the electrified powertrain includes a plurality of drive axles each coupled to a respective one of the electric traction motors. The controller in such an exemplary embodiment is configured to execute a costing function to allocate the desired torque to the drive axles during the MPM to thereby balance thermal loading and wear of the electric traction motors and the TPIMs.

In another aspect of the disclosure, an electrified powertrain includes a direct current (DC) power supply configured to provide a DC voltage, a polyphase electric traction motor having a stator and a rotor, the latter being configured to couple to a mechanical load. The electrified powertrain in this embodiment also includes a TPIM configured to convert the DC voltage from the DC power supply to an alternating current (AC) voltage, and to deliver the AC voltage to the stator. A controller is configured to execute the method described above.

A motor vehicle is also disclosed herein having road wheels, an accelerator pedal, and an electrified powertrain. The electrified powertrain includes a high-voltage battery pack providing a DC voltage, a TPIM, and a polyphase electric traction motor having a stator and a rotor, with the rotor coupled to one or more of the road wheels. A controller of the electrified powertrain is configured to execute the present method as described herein.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic illustration of a representative motor vehicle with a maximum performance mode (MPM) providing enhanced electric drive capabilities in accordance with the present disclosure.

FIG. 2 is a flow chart describing a propulsion control method for use with the electrified powertrain shown in FIG. 1.

FIG. 3 is a schematic illustration of exemplary control logic usable by the controller shown in FIG. 1.

FIG. 4 is a schematic flow diagram describing a costing function-based arbitration method for balancing thermal loading and wear in multiple drive axle scenario.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

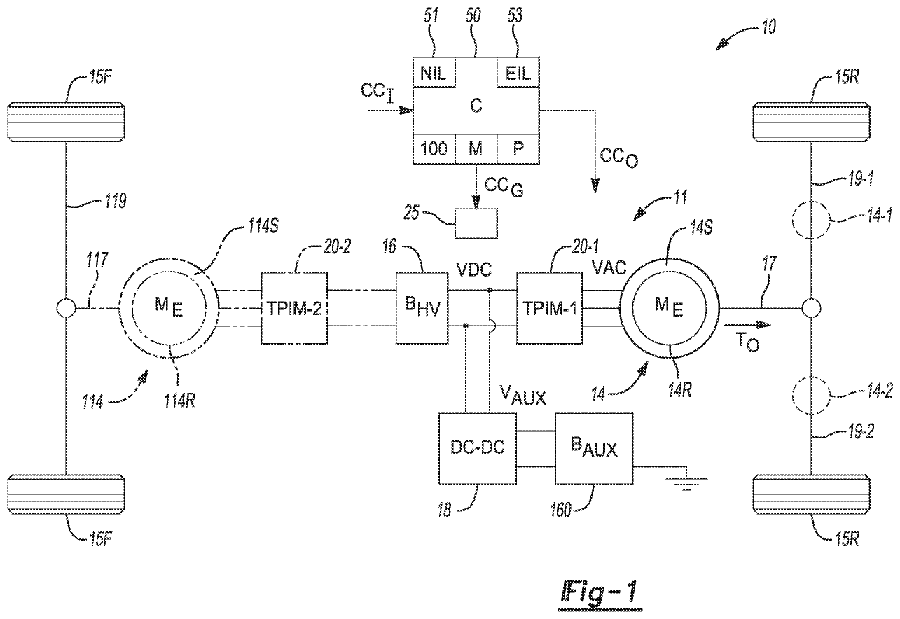

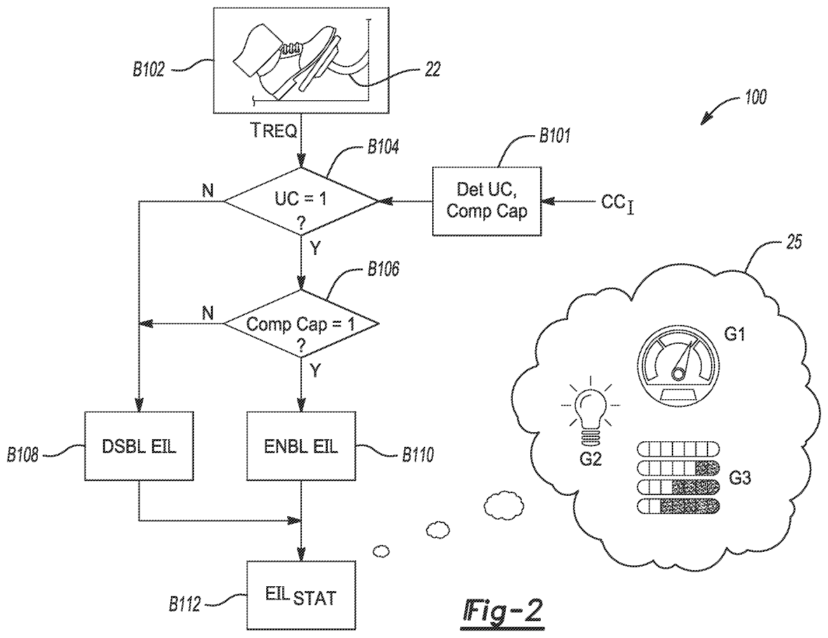

Referring to the drawings, wherein like reference numbers refer to like features throughout the several views, an electrified powertrain 11 configured to selectively enter an enhanced maximum performance mode (“MPM”) is schematically depicted in FIG. 1. Entry into MPM occurs via selective application of an extended inverter limit/EIL 53 of an onboard controller (C) 50 as described below with reference to FIGS. 2-4, with MPM allowing an operator of the electrified powertrain 11 to temporarily enjoy a boosted performance level relative to a default/normal performance level. When the electrified powertrain 11 is used aboard a motor vehicle 10, for instance, MPM provides improved acceleration from a standstill or comparation passing maneuvers, among other possible use scenarios.

For illustrative simplicity, select components of the electrified powertrain 11 are shown and described in detail below while other components are omitted. The electrified powertrain 11 may be used aboard the motor vehicle 10 or another mobile platform, e.g., watercraft, aircraft, rail vehicles, etc. In the depicted representative embodiment of FIG. 1, the motor vehicle 10 is configured as a typical road vehicle having front and rear road wheels 15F and 15R, respectively, in rolling contact with a road surface, with “F” and “R” respectively referring to a front and rear corner positions of the motor vehicle 10. The actual number of road wheels 15F and 15R may vary with the intended application, with as few as one being possible, for instance motorcycles, scooters, or e-bikes, and with more than the illustrated number being possible in other configurations.

The electrified powertrain 11 includes an electric traction motor (ME) 14, which in the illustrated embodiment is coupled to the rear road wheels 15R via an output member 17 and respective drive axles 19-1 and 19-2. Alternatively, the electric traction motor 14 may be embodied as individual electric traction motors 14-1 and 14-2 respectively coupled to the drive axles 19-1 and 19-2. The electric powertrain 11 may include another electric traction motor (ME) 114 coupled to the front road wheels 15F via another output member 117 and a drive axle 119. Thus, the particular number and arrangement of the electric traction motors 14, 14-1, 14-2, and/or 114 may vary with the application.

The electric traction motors 14 and 114 are coupled to and powered by a respective first and second traction power inverter module (TPIM-1) 20-1 and (TPIM-2) 20-2. For illustrative simplicity, associated TPIMs for the optional electric traction motors 14-1 and 14-2 arranged on drive axles 19-1 and 19-2 are omitted from FIG. 1, with the description of the electric traction motors 14 and 114 applying as well to operation of electric traction motors 14-1 and 14-2. Operation of the electric traction motors 14 and 114 and their respective TPIMs 20-1 and 20-2 is closely governed by the controller 50 according to calibrated normal inverter limits (NIL) 51 and, at times, via the above-noted EIL 53, as described in detail below with reference to FIGS. 2-4.

Described herein in relative terms as stated percentages, the default NIL 51 are enforced by the controller 50 up to 100% of a calibrated baseline thermal limit or threshold, with inverter temperature typically being a particular value encoded in control input signal (arrow CO to the controller 50 and used for this purpose. Using a nominal temperature threshold T_{100%}, for example, de-rating via switching control of the TPIMs 20-1 and/or 20-2 would occur when the measured or estimated temperature exceeds T_{100%}. Operation according to the EIL 53 thus temporarily increases the limits provided by the NIL 51.

For example, T_{100%} of the NIL 51 in a non-limiting representative scenario could be increased via application of the EIL 53, e.g., to T_{129%}. Upon application of the EIL 53, the new control threshold increases to T_{129%}. Importantly, the controller 50 enters MPM not when present conditions such as an instantaneous temperature fall within the EIL 53, but rather when the impending EIL-boosted driving maneuver can be completed without exceeding T_{129%} at any point of the boosted driving maneuver. MPM/EIL entry conditions and thresholds are calibratable to cover different permitted use cases across a wide range of vehicles, weather conditions, drive modes, and/or operators to minimize adverse hardware effects and optimize operator satisfaction. Within the scope of the present disclosure, therefore, entry into MPM is selectively permitted when a boosted electric propulsion capability is expected, via modeling, estimation, or other forward-looking logic of the controller 50, to remain available over the full duration of the impending boosted driving maneuver, with entry into MPM not otherwise permitted.

The present approach may be understood with reference to a representative 0-60 MPH acceleration maneuver before which an inverter/motor temperature falls well within an allowed temperature range. This alone would not be sufficient grounds for launching under EIL 53 in accordance with the present control strategy. Instead, the controller 50 would situationally and conditionally allow entry into MPM once the controller 50 ascertains whether, at completion of the MPM, thermal or other relevant conditions remain within the EIL 53. At the same time, the controller 50 communicates an availability status to the operator to help manage performance expectations. Other aspects of the disclosure may be used to balance thermal loading and component wear aboard the electrified powertrain 11. The various aspects of the strategy are described in detail below with reference to FIGS. 2-4.

With continued reference to FIG. 1, the electric traction motor 14 is connected to and energized by a DC voltage supply, in this instance a rechargeable high-voltage battery pack (BHV) 16. This occurs through cooperative operation of the controller 50 and the TPIM 20-1, with the TPIM 20-1 being electrically connected to individual phase windings (VAC) of the electric traction motor 14, e.g., using AC cables. Through switching control of the TPIM 20-1, the TPIM 20-1 converts a DC voltage from the battery pack 16 to a variable frequency, variable amplitude polyphase/AC voltage to energize the electric traction motor 14 and produce a desired torque (arrow T_{O}). Rotation of a cylindrical rotor 14R of the electric traction motor 14 powers the rear road wheels 15R in the non-limiting embodiment of FIG. 1. Hybrid embodiments may be envisioned within the scope of the disclosure in which an internal combustion engine (not shown) or another torque source or prime mover works alone or in conjunction with the electric traction motor 14 to generate propulsion torque in a mode-specific manner.

The electric traction motor 14 in the illustrated embodiment is a polyphase/AC rotary electric machine having the cylindrical rotor 14R and a cylindrical stator 14S. In a typical radial flux configuration, the rotor 14R may be coaxially arranged with respect to the stator 14S, such that the stator 14S surrounds the rotor 14R, with axial flux-type machines also being usable within the scope of the present disclosure. The rotor 14R is coupled to a mechanical load, such as one or more of the road wheels 15R, via output member 17. Output member 17, which may be embodied as a rotatable gear set, shaft, or other mechanical mechanism, may be connected to the rear road wheels 15R via drive axles 19-1 and/or 19-2 and/or an intervening gear box/transmission (not shown), with the output member 17 ultimately transmitting output torque (arrow To) from the electric traction motor 14 to the rear road wheel(s) 15R to propel the vehicle 10.

The present teachings may be applied to a single-motor configuration in which the electric traction motor 14 is the sole prime mover of the electrified powertrain 11. Alternatively, the additional traction motor 114 with a stator 1145 and rotor 114R may be used to power the front road wheels 15F, e.g., using the TPIM 20-2, or the individual electric traction motors 14-1 and 14-2 may be disposed on the partial axles 19-1 and 19-2, such that the motor vehicle 10 has two or three traction motors in total. For simplicity, although multiple electric traction motors and TPIMs may be used in the scope of the disclosure as noted above, operation of a method 100 in accordance with the present disclosure is described herein using the electric traction motor 14 and its connected TPIM 20-1 as representative hardware.

To optimize electric drive performance, the controller 50 and the TPIM 20-1 utilize intelligent system controls and hardware calibration flexibility, via execution of a method 100 as described below with reference to FIG. 2, to selectively enter MPM. In MPM, the controller 50 applies the EIL 53 in lieu of the NIL 51. As noted generally above, MPM is a reserved operating mode that may be made selectively available on certain motor vehicles 10, such as performance sedans or trucks, in order to situationally permit an operator to temporarily access increased propulsion capabilities. This occurs by operation of the controller 50 using the higher than normal propulsion component durability limits of the EIL 532. To this end, the controller 50 is programmed in software and equipped in hardware, i.e., configured, to execute instructions embodying the method 100 under certain limited circumstances when extra propulsion capability is available not only at the onset of an MPM maneuver, but also through the maneuver's full duration. The controller 50 is also configured to communicate an availability status signal (arrow CCG) to an operator of the motor vehicle 10 to activate an indicator device 25, and thus to help manage the operator's performance expectations relative to current availability of MPM.

Still referring to FIG. 1, other components of the electrified powertrain 11 may also include a DC-to-DC voltage converter 18 and a low-voltage/auxiliary battery (B_{AUX}) 160. The high-voltage propulsion battery pack 16 is connected to the TPIM 20 via a high-voltage bus (VDC), with typical voltage levels of such a high-voltage bus being 300V or more, or other voltage levels in excess of auxiliary/12-15V levels of the auxiliary battery 160. However, as the vehicle 10 may also include a myriad of low-voltage systems, a low-voltage bus (V_{AUX}) may be powered by the DC-to-DC converter 18, which in turn may be used to maintain a low-voltage charge level of the auxiliary battery 160.

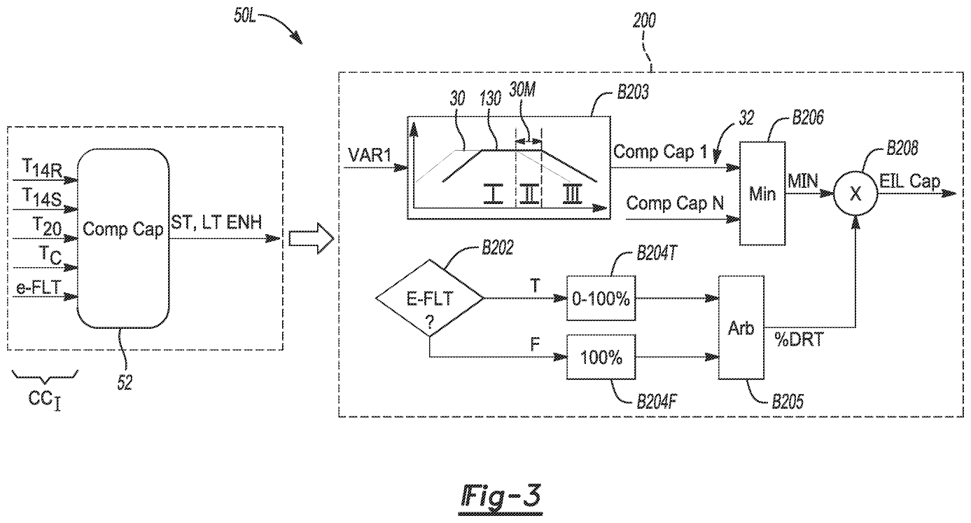

The controller 50 of FIG. 1 may be configured to execute other diagnostic and control functions in addition to those that are immediately germane to the present method 100 of FIGS. 2 and 3. For example, the controller 50 may be a hybrid control unit, a transmission control unit, or another suitable standalone or networked vehicle controller for the purposes of the present disclosure. As such, the controller 50 may be embodied as one or more electronic control units or computational nodes responsive to input signals (arrow CO inclusive of measured or estimated temperatures of the various electric traction motors 14, 14-1, 14-2, and/or 114 and associated TPIMs by transmission of control signals (arrow CC_{O}) to the electrified powertrain 11, both in the course of executing the method 100 and when executing other possible control actions.

For the purposes of executing the method 100, the controller 50 is equipped with application-specific amounts of the volatile and non-volatile memory (M) and one or more of processor(s) (P), e.g., microprocessors or central processing units, as well as other associated hardware and software, for instance a digital clock or timer, input/output circuitry, buffer circuitry, Application Specific Integrated Circuits (ASICs), systems-on-a-chip (SoCs), electronic circuits, and other requisite hardware as needed to provide the programmed functionality. The indicator device 25, such as a digital gauge, display, and/or light-emitting diodes, may be mounted within a passenger compartment of the representative vehicle 10 in easy view of the operator. Such an indicator device 25 is in communication with the controller 50, e.g., over low-voltage differential lines and/or wirelessly, and is responsive to availability status signal (arrow CCG) to enable the controller 50 to inform an operator of the vehicle 10 as to the present availability of the MPM/EIL. The process of discerning precisely when to allow entry into such a mode will now be described with reference to FIGS. 2-4.

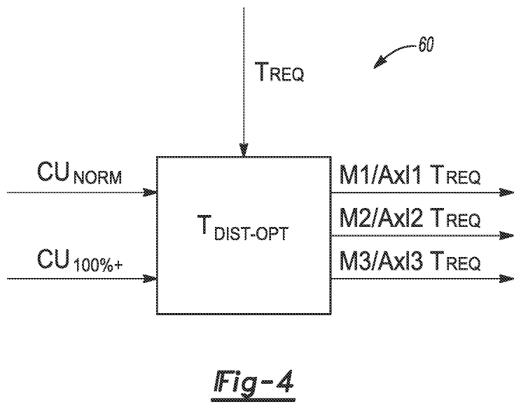

Referring to FIG. 2, a representative embodiment of the present method 100 is automatically executed by the controller 50 of FIG. 1 during operation of the electrified powertrain 11 to selectively enable operation of the electrified powertrain 11 in the above-noted maximum performance mode (MPM). This may occur when certain use cases are present in conjunction with current component capabilities as described below. Typical use cases may be an acceleration event corresponding to a wide-open throttle or wide-open pedal maneuver, a high-speed passing maneuver, or other maneuvers whose performance would be enhanced by temporarily expanding upon the NIL 51 used as default/nominal 100% limits. In order to limit component warranty exposure, partial-pedal and single-axle entry into MPM may be prevented or curtailed as part of the method 100, with possible arbitration and load balancing performed in multi-axle drive configurations as set forth below with particular reference to FIGS. 3 and 4. Additionally, the use of the indicator device 25 of FIG. 1 may complement a goal of the present teachings by graphically depicting a real-time availability status of the enhanced propulsion capabilities of MPM, as described in FIG. 2.

Commencing with logic block B 101 of FIG. 2, the method 100 in an exemplary embodiment includes receiving the input signals (arrow CC_{I}) indicative of a requested torque, i.e., a desired output torque from the electric traction motor 14. The input signals (arrow CC_{I}) are also inclusive of measured or estimated temperatures of the exemplary electric traction motor 14/TPIM 20-1 or other motor/TPIM combinations via the controller 50 shown in FIG. 1. As appreciated in the art, a power inverter such as the TPIM-1, the TPIM-2, or other TPIMs usable aboard the motor vehicle 10 typically include a temperature sensing thermistor or thermocouple configured to measure and report switch junction or other relevant operating temperatures to the controller 50, which would be includes as part of the input signals (arrow C_{I}). Temperature values may be provided from other locations, including but not limited to the battery pack 16 of FIG. 1, the electric traction motors 14, 114, 14-1, and 14-2, coolant temperatures, etc. Other values that may be included in the input signals (arrow C_{I}) are set forth below.

In response to the input signals (arrow C_{I}), the controller 50 accesses the NIL 51 and the EIL 53, such as by accessing a lookup table in memory (M) of the controller 50. This enables the controller 50 to determine the current use case and component compatibility (“Det UC, Comp Cap”) of the electrified powertrain 11. With respect to the latter term “use case” as employed herein, a given manufacturer of the motor vehicle 10 shown in FIG. 1 may program the controller 50 to look for certain operating modes or drive states of the electrified powertrain 11 in which the extended inverter limit (EIL) may be selectively enacted to enable MPM functionality. For example, an operator of a performance sedan or truck may at times desire an increased 0-60 MPH acceleration performance when accelerating from a standstill, such as during a wide-open throttle/wide-open pedal when aggressively launching.

As understood in the art, a common performance benchmark for evaluating certain performance vehicles is its 0-60 MPH (0-96.6 KPH) acceleration performance. Acceleration during high-acceleration passing maneuvers or under other driving conditions likewise may be an enabling use condition within the scope of the disclosure. Thus, a manufacturer may limit execution of the method 100 and entry into MPM to certain makes or models of the motor vehicle 10 of FIG. 1 as a use case, and/or the controller 50 may be programmed to allow an operator to set a default use case, which the controller 50 may still override based on a real-time state of the electrified powertrain 11 as set forth herein. In the latter example, an operator with requisite driving skills may possibly disable the method 100 for other drivers in the operator's household, for instance less experienced or beginning drivers.

With respect to component durability/capability, thermodynamic values potentially affecting the short-term and long-term performance and durability of the electrified powertrain 11 of FIG. 1 are included in the input signals (arrow CC_{I}) communicated to the controller 50. For example, the input signals (arrow CC_{I}) may include an operating temperature of the rotor 14R, the stator 14S, and/or other moving or static parts of the electric traction motor 14, the TPIM 20, e.g., switching junctions and switching die temperatures thereof, and/or the high-voltage battery pack 16 as noted above. Other values relevant to performing logic block B101 may include state of charge (SOC) of the high-voltage battery pack 16 and/or its constituent electrochemical battery cells (not shown), a temperature of an electrical coolant (not shown) circulated through the electrified powertrain 11, etc. The method 100 then proceeds to logic block B104.

Logic block B102 of FIG. 2 includes determining or receiving, via the controller 50 as part of the input signals (arrow CC_{I}), a requested torque (T_{REQ}) and/or speed of the electric traction motor 14, or any of its alternatives 114, 14-1, and/or 14-2. Relevant operator requests falling within the scope of logic block B102 may include an amount of travel of an accelerator pedal 22 or an analogous acceleration foot-operated or hand-operated input device, and possibly other dynamically-changing input parameters such as steering angle/rate, braking levels, etc. Such values are measured or estimated and thereafter communicated to the controller 50, such as over a controller area network (CAN) bus, differential voltage lines, and/or wirelessly. The method 100 then proceeds to logic block B104.

At logic block B104 of FIG. 2, the controller 50, using the data collected in block B101, determines whether a predetermined use case is active (“UC=1?”). To encode block B104, the controller 50 may be programmed with predetermined approved use cases for the particular motor vehicle 10 and/or operator thereof, such as an acceleration from a standstill maneuver, a high-speed passing maneuver, or a particular traction maneuver. The controller 50 at logic block B104 then compares a current use case corresponding to the present state of the motor vehicle 10, and possibly the above-noted preassigned permissions, to the predetermined approved use cases. The method 100 proceeds to logic block B106 when the current use case is a predetermined approved use case, with the controller 50 proceeding in the alternative to logic block B108 when the current use case does not match a predetermined approved use case, e.g., one of a number of calibrated/pre-programmed use cases stored in memory (M) of the controller 50.

At logic block B106, the controller 50 next compares the current component capability to a calibrated capability threshold, which may be an aggregate or blended combination of different component capabilities and thresholds as described below with reference to FIG. 3. The controller 50 effectively determines whether a predetermined margin exists in the current component capability for operating the electrified powertrain 11 for a full duration of a boosted driving maneuver, i.e., in MPM.

As part of logic block B106, an embodiment may be contemplated in which the controller 50 looks to the present temperatures of the electric traction motor 14, TPIM 20-1, and/or other affected hardware components and determines whether such values fall within a range encoded in the EIL 53. However, this is not the end of the analysis in logic block B106. The controller 50 is also programmed to look ahead in time to an end of the impending MPM-boosted maneuver to determine whether, at the maneuver's anticipated completion, the affected components will not be outside of their respective limits as encoded in the EIL 53.

By way of example, one may assume the NIL 51 of FIG. 1 could include a nominal temperature threshold T_{100%}, e.g., 40° C. De-rating via control of the TPIMs 20-1 and/or 20-2 would ordinarily occur, outside of MPM operation, when the measured or estimated temperature exceeds 40° C. in this non-limiting example. With EIL 53 applied, the threshold may be situationally increased to T_{129%}, or about 52° C. in this illustrative example. If at the expected entry to MPM the measured temperature of the TPIM-1 is 35° C., typical control strategies might enable MPM when the entry temperature falls within the normal and extended limits. However, the present strategy does not function in this manner.

Instead, the controller 50 of FIG. 1 looks ahead in time to the expected completion of the boosted driving maneuver to estimate whether the temperatures being considered will exceed the extended limits, in this instance T_{129%}. If the boosted driving maneuver cannot be completed without exceeding the extended limits, the MPM maneuver is not enabled. Thus, if the controller 50 is programmed with or estimates an expected 20° C. rise in inverter temperature for a 0-60 MPH wide open pedal/throttle maneuver, the EIL 53 sets forth a thermal limit of 52° C., and the temperature prior to entering MPM is 35° C., the controller 50 would not enable the maneuver, as doing so would see an ending temperature of 55° C., i.e., 3° C. above the thermal limits of the EIL 53. Different ranges for the EIL 53 could be used for different conditions, including limits informed from a collective time history descriptive of past thermal loading of the TPIM 20-1 and the electric traction motor 14, elapsed durations of operation above the increased limits, etc., to fine tune the performance of the method 100 to a given motor vehicle 10.

In this manner, the controller 50 shown in FIG. 1 determines whether the current component capability is within and is expected to remain within an allowable range for proceeding with the EIL 53 and the remainder of method 100, i.e., “Comp Cap=1?”. Reference levels of EIL 53 may be programmed into one or more lookup tables in memory (M) of the controller 50 or otherwise made available to the controller 50. The method 100 proceeds to logic block B110 when the present component capability is above the current capability threshold suitable for entering and remaining in MPM through the maneuver's completion by application of the EIL 53 of FIG. 1. Otherwise, the method 100 proceeds to logic block B108.

Logic block B108 is arrived at when either the current use condition (logic block B104) or the current component capability (logic block B106) precludes entry into MPM. In this instance, the controller 50 of FIG. 1 may automatically disable MPM/EIL functionality (“DSBL EIL”), such as by setting a bit code which prevents operation of the electrified powertrain 11 above the limits of its default torque and speed operating range. The method 100 then proceeds to logic block B112.

Logic block B110 is arrived at when the current use condition (block B104) and the current component capabilities (block B106) both permit entry into MPM. In this instance, the controller 50 of FIG. 1 automatically enables the EIL 53, such as by setting a bit code which temporarily allows operation of the electrified powertrain 11 outside of its default normal torque and speed operating limits of the NIL 51 in favor of the EIL 53. Thus, in response to the input signals (arrow CCI) when a predetermined margin exists in the component capability, e.g., when 25° C. remain between a current temperature of the TPIM 20-1 and a temperature limit of the EIL 53 when a rise of 20° C.° is expected for an impending boosted driving maneuver, the controller 50 temporarily applies the EIL 53 to enable MPM. Application of the EIL 53 thus allows operation of the electric traction motor 14 to occur above default NIL 52-based torque and speed operating limits, or more specifically the associated temperatures thereof, for the full duration of the boosted driving maneuver. The method 100 then proceeds to logic block B112.

At logic block B112, the controller 50 of FIG. 1 may communicate the current availability status (“EILsTAT”) of the MPM/EIL to the operator of the vehicle 10 via the indicator device 25. As noted above, MPM/EIL is not enabled unless and until the controller 50 determines that a current use case maneuver, such as 0-60 MPH acceleration, can be started and completed within short-term and long-term component durability limits. Only in those cases does the controller 50 apply the EIL 53 to allow execution of the MPM to continue. Because entry into MPM is not always available to an operator in the course of a given drive cycle, the method 100 also incorporates intuitive audio and/or visual feedback to the operator to help manage the operator's MPM-related performance expectation.

By way of example and not limitation, a possible use scenario is one in which a driver of a high-performance version of the motor vehicle 10 is stopped at a traffic light. When the light changes, the driver may expect an immediate acceleration boost that would ordinarily accompany MPM operation. However, if the current use case is not enabled and/or a current component capability is at an unfavorable level, thus precluding entry into MPM as explained above, the driver would not experience the expected acceleration response when the light turns green and the driver fully depresses the accelerator pedal 22. In this case, the driver's expected performance will not be delivered by the electrified powertrain 11.

Absent use of the indicator device 25, the driver in this exemplary scenario might not be aware of non-availability, and may interpret the lack of boost as a fault or deficiency in the electrified powertrain 11. Likewise, MPM could be enabled but discontinued midway through a boosted driving maneuver, which could lead to driver dissatisfaction in a similar manner. Feedback enabled by logic block B112 is therefore intended to alleviate uncertainty as to the present and sustained availability of MPM, or lack thereof, while possibly conveying other information of interest to the driver. In this manner, the driver remains fully aware of when boosted performance may be expected, as enabled by imposition of the EIL 53, and when the same driver could reasonably expect normal/default acceleration performance within the scope of the NIL 51 of FIG. 1.

While a range of embodiments for the indicator device 25 are possible within the scope of the disclosure, a few representative examples are depicted for use in the motor vehicle 10 of FIG. 1. A digital and/or analog needle gauge G1 may be mounted within an instrument panel (not shown) of the vehicle 10. The gauge G1 may be color-coded to present a graduated performance range that an operator, at a glance, may use to discern the present availability of MPM/EIL. Exemplary colors could for instance include green to convey MPM/EIL availability, orange or amber to convey limited availability, and red to convey non-availability. While omitted for simplicity, the gauge G1 could include textual information that informs the operator as to the particular reason or reasons for limited availability or total non-availability.

Alternative or complementary indicator devices 25 may include a light bulb G2 such as one or more color-coded LEDs, e.g., in keeping with the green, amber, and red example of gauge G1, or another suitable visual indicator, or a digital bar gauge G3 presenting the information of gauge G1 in a simpler manner, and perhaps requiring less surface area to implement on an instrument panel. Visual feedback enabled by the indicator device 25 may be enhanced in some embodiments using haptic and/or audio feedback. One or more LEDs of the digital bar gauge G3 or either of gauges G1 or G2 may be illuminated with a color indicative of the availability status. In the various embodiments, the gauge G1, G2, or G3 may be responsive to the availability status signal (arrow CCG) shown in FIG. 1.

FIG. 3 depicts representative control logic 50L for implementing aspects of the present method 100. As disclosed above, the input signals (arrows CCI) are measured or estimated and fed into a component capability (“Comp Cap”) logic block 52 of the controller 50. Exemplary parameters may include, without limitation, a measured or estimated rotor temperature (T_{14R}) of the rotor 14R depicted in FIG. 1, a stator temperature (T_{14S}) of the stator 14S, an inverter temperature (T₂₀) of the TPIM 20-1, and/or a coolant temperature (T_{C}) of electrical coolant (not shown) circulated around or through the various components of the electrified powertrain 11 shown in FIG. 1. An electric fault (“e-FLT”) signal may also be used as part of the input signals (arrow CCI). Logic block 52, using the input signals (CCI), may then determine short-term and long-term enhanced capabilities (“ST, LT ENH”) of the electrified powertrain 11 for implementing the extended inverter limit and thereby entering MPM, with the capabilities being those of the electric traction motor 14, the TPIM 20-1, the HV battery pack 16, and other possible components.

The control logic 50L of FIG. 3 may be further explained with reference to accompanying logic 200, which may be adapted for use as part of the present method 100 with multiple variables or parameters. A representative generic variable (“VAR1”) is depicted for illustrative simplicity. At logic block B202, the controller 50 of FIG. 1 may determine if an electrical fault of the TPIM 20-1 or another component of the electrified powertrain 11 is active, as indicated by “E-FLT?” in FIG. 3. Electrical component faults within the context of logic block B202 may be hard faults such as short circuit conditions, welded contactors, operation close to a critical operating temperature, etc. The method 200 proceeds to logic block B204T when no such faults are detected, and to logic B204F in the alternative when at least one electrical fault is detected.

At logic block B203, a magnitude of the generic variable (VAR1) may be compared to predetermined limits to determine the above-noted component capability. Trace 30 corresponds to long-term component limits, with trace 130 corresponding to short-term component limits. As noted above, the controller 50 applies the EIL 53 if the long-term capability of trace 30 is at its maximum. The controller 50 would then exit EIL 53 if the short-term capability (trace 130) is no longer at maximum. Because the long-term component capability (trace 30) has a more conservative margin (30M) built in, the controller 50 would be able to complete the boosted driving maneuver in MPM before the temperature or other relevant parameter changes too much.

For example, trace 30 may be used to define discrete performance regions, with three such performance regions labeled I, II, and III in the area under the limit trace 30. By way of illustration and not limitation, the generic variable (VAR1) may be a temperature of the TPIM 20-1, with the regions I, II, and III respectively corresponding to “too cold”, “acceptable”, and “too hot”. Logic block B203 then outputs a corresponding component capability value 32 (“CompCap 1”) to logic block B206. Similar traces (not shown) may be used for a multiple (N) of other variables, including some or all of the input signals (CCI) in FIG. 3, with “CompCap N” indicating the 1, . . . N different possible component capabilities being fed to logic block B206.

Logic blocks B204T and B204F respectively entail de-rating the electric traction motor 14/TPIM 20-1 or other TPIMs and motors within the electrified powertrain 11, in response to the fault determination of logic block B202. In logic block B204T, a default setting may correspond to 0% de-rating, i.e., the TPIM 20-1 and/or the electric traction motor 14 may be initially set to operate at a default torque and speed setting or operating point. In contrast, logic block B204F is executed in response to detection of an electrical fault at logic block B202. Depending on the nature of the detected electrical fault, logic block B204F may include de-rating the TPIM 20-1 by 100% for serious faults, or de-rating by some lesser amount to provide limited functionality of the electric traction motor 14. The method 200 then proceeds to logic block B205.

At logic block B205, the controller 50 may arbitrate between the outputs of logic blocks B204T and B204F based on the present result of logic block B202, e.g., over a calibrated sampling interval, with the controller 50 outputting a de-rating percentage (“% DRT”) based on the results. Logic block B205 may include averaging the outputs of logic blocks B204T and B204F, or weighting the output of one of the logic blocks B204T or B204F more than the other in different embodiments, or calculating the derating percentage using other criteria, e.g., a formula. The de-rating percentage is then provided to logic block B208.

Logic block B206 may entail receiving the 1, . . . N different possible component capabilities from logic block(s) B203 as described above, and then finding the most-restricted or limited of the component capabilities using a comparator or other suitable minimum (Min) function. The method 200 then feeds the minimum component capability to logic block B208.

At logic block B208, the controller 50 may multiply the outputs of blocks B205 and B208 to determine the EIL limits (“EIL Cap”) for use in controlling the electrified powertrain 11 once EIL is enabled at logic block B110 of FIG. 2.

Within the scope of the disclosure, it may be prudent for component warranty exposure purposes to curtail or prevent entry into MPM when the electrified powertrain 11 operates in a partial-pedal or single-axle use case. For instance, referring again to FIG. 1, electric traction motors 14 and 114, with the corresponding TPIMs 20-1 and 20-2, could be used in lieu of the electric traction motor 14 as noted above. Use of multiple powered drive axles 19-1, 19-2, and 119 thus enables all-wheel drive (AWD) functionality. When driving in such an AWD embodiment in inclement weather with an onboard traction control system in an active state, the controller 50 of FIG. 1 could potentially determine, through operation of the method 100, that entry into MPM may be implemented on one drive axle but not the other, or precluded altogether. A partial-pedal condition may likewise correspond to a high torque request for powering the rear road wheels 15R, while at the same time calling for lower torque to the front road wheels 15F, or vice versa.

However, operating in this manner may increase thermal loading and wear, and short-term or long-term warranty exposure on a corresponding electric traction motor 14 or 114, e.g., for driving the rear road wheels 15. The controller 50 may therefore preclude MPM or at least adjust torque distribution during operation in MPM in response to an active traction control state, or the controller 50. The actual torque distribution may be arbitrated in real time by the controller 50, in other words, to provide something short of a full wide-open throttle or pedal performance on a given one of the drive axles 19.

Referring now to FIG. 4, exemplary costing-based approach for implementing such thermal balancing via torque arbitration is shown in which an optimization block (“T_{DIST-OPT}”) 60 is used as part of the controller 50 shown in FIG. 1. The driver's total torque request (arrow TREQ) is used as a control input to the optimization block 60. Additionally, the optimization block 60 receives two different costing inputs: (1) normal cost usage (arrow CU_{NORM}), e.g., associated costs in terms of efficiency, vehicle dynamics, traction, etc., of operation according to the NIL 51 of FIGS. 1, and (2) cost usage for operation in MPM above the nominal 100% limits (arrow CU_{100%+}), the latter being associated with normal/default operation under the EIL 53 of FIG. 1.

Outputs of the optimization block 60 include multiple different axle torques from different electric traction motors, nominally Ml, M2, and M3, and corresponding allocated portions of the total torque request (arrow T_{REQ}), i.e., Axl1 TREQ, Axl2 T_{REQ}, and Axl3 T_{REQ}. In the exemplary embodiment of FIG. 1, for instance motors M1, M2, and M3 may respectively correspond to electric traction motors 114, 14-1, and 14-2 in a non-limiting three-axle configuration. However, the strategy of FIG. 4 could be applied to a two-axle configuration in which the torque allocation is made between the electric traction motors 14 and 114 in another embodiment.

The optimization block 60 of FIG. 4 may perform a type of “soft-costing” on individual motor usage above 100% capability, selectively penalizing operation above 100% limits of the NIL 51. The costing function itself may vary with the application, and may include number of associated factor weights which collectively balance the load on the various electric traction motors 114, 14-1, and 14-2 and their associated TPIMs. For example, the controller 50 may look to the cost of allocating the torque requested by the driver in the total torque request (arrow TREQ) to a given drive axle 19-1, 19-2, or 119. While the optimization block 60 could conceivably apportion or allocate the total torque request (arrow T_{REQ}) to the various motors Ml, M2, and M3 in some scenarios, the optimization block could also disproportionately allocate the total torque request (arrow T_{REQ}) to one of the drive axles.

As an illustrative example, before allocating a given percentage of the total torque request (arrow T_{REQ}) to a given drive axle 119, 19-1, or 19-2, the controller 50 may use the illustrated costing approach to determine the effect of doing so on a given motor M1, M2, or M3 connected thereto, as well as the associated TPIM. Past history of thermal loading of a given device may inform such an allocation as part of the applied costing function. For instance, if motor M1 (e.g., the electric traction motor 114 of FIG. 1) has, over a predetermined number of prior drive cycles, experienced an accumulative thermal loading well in excess of that of motors M2 and M3, even if the motor M1 could operate according to the EIL 53 during MPM operation, the controller 50 may restrict M1's contribution to help reduce M1's thermal loading and wear. Similar calculations could be performed for other factors that tend to adversely affect hardware such as battery current/power usage above 100% capability, as will be appreciated.

Control of the electrified powertrain 11 of FIG. 1 in accordance with the method 100 of FIG. 2, as further refined with reference to the optimization block 60 of FIG. 4, thus enables an operator of the motor vehicle 10 shown in FIG. 1 to more reliably enjoy the boosted acceleration performance provided by MPM operation. For example, the controller 50 may enable entry into MPM in accordance with the EIL 53 of FIG. 1 when the operator is able to obtain consistent 0-60 MPH acceleration performance through the full duration of the maneuver. The controller 50 may selectively limit expanded functionality to predefined use cases, such as wide-open throttle or pedal in which the operator requests torque performance exceeding default component limits, e.g., 129% torque relative to a 100% default limit.

Additionally, the present teachings contemplate active real-time audio, visual, and/or haptic feedback to the operator to inform the operator of the present availability or lack thereof of entry into MPM. Enhanced performance and drive enjoyment are thus enabled while maintaining awareness of short term and long term component durability. These and other possible advantages will be readily apparent to those of ordinary skill in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A method for controlling an electrified powertrain having an electric traction motor and a traction power inverter module (TPIM), the method comprising:
determining a current component capability and a current use case of the electrified powertrain via a controller;
in response to the current component capability being less than a calibrated capability threshold and the current use case matching a predetermined approved use case, determining whether a predetermined margin exists in the current component capability for operating the electrified powertrain in a maximum performance mode (MPM) for a full duration of a boosted driving maneuver;
receiving, via the controller, input signals indicative of a requested torque, the requested torque being a desired output torque level of the electric traction motor; and
in response to the input signals when the predetermined margin exists, temporarily applying an extended inverter limit (EIL) of the TPIM, via the controller, to thereby enable the MPM, wherein application of the EIL allows operation of the electric traction motor to occur above default torque and speed operating limits for the full duration of the boosted driving maneuver.

2. The method of claim 1, further comprising: communicating an availability status of the MPM to an operator of the electrified powertrain via an indicator device prior to applying the EIL, the availability status being indicative of an availability of the MPM for the full duration of the boosted driving maneuver.

3. The method of claim 1, further comprising:
in response to the current component capability not exceeding the calibrated capability threshold or the current use case not matching the predetermined approved use case, disabling the EIL via the controller.

4. The method of claim 1, wherein the electrified powertrain includes an accelerator pedal, the input signals include an amount of pedal travel of the accelerator pedal, and the predetermined approved use case is a wide-open throttle or wide-open pedal condition of the accelerator pedal indicative of a predetermined acceleration event.

5. The method of claim 4, wherein the predetermined approved use case is an acceleration-from-a-standstill maneuver and/or a high-speed passing maneuver.

6. The method of claim 4, further comprising selectively disabling the EIL in response to an active traction control state.

7. The method of claim 1, wherein the indicator device is a digital gauge, and wherein the controller is configured to communicate the availability status of the MPM by illuminating one or more light-emitting diodes of the digital gauge with a color indicative of the availability status.

8. The method of claim 1, wherein the electric traction motor includes a plurality of electric traction motors, the TPIM includes a plurality of TPIMs each connected to a respective one of the electric traction motors, and the electrified powertrain includes a plurality of drive axles each coupled to a respective one of the electric traction motors, wherein the controller is configured to execute a costing function to allocate the desired torque to the drive axles during the MPM to thereby balance thermal loading and wear of the electric traction motors and the TPIMs.

9. An electrified powertrain comprising:
a direct current (DC) power supply configured to provide a DC voltage;
a polyphase electric traction motor having a stator and a rotor, wherein the rotor is configured to couple to a mechanical load;
a traction power inverter module (TPIM) connected to the stator and to the DC power supply, wherein the TPIM is configured to convert the DC voltage from the DC power supply to an alternating current (AC) voltage, and to deliver the AC voltage to the stator; and
a controller configured to:
determine, using the input signals, a current component capability and a current use case of the electrified powertrain;
in response to the current component capability being less than a calibrated capability threshold and the current use case matching a predetermined approved use case, determine whether a predetermined margin exists in the current component capability for operating the electrified powertrain in a maximum performance mode (MPM) for a full duration of a boosted driving maneuver;
receive input signals indicative of a requested torque, the requested torque being a desired output torque level of the electric traction motor; and
in response to the input signals when the predetermined margin exists, temporarily apply an extended inverter limit (EIL) of the TPIM to thereby enable the MPM, wherein application of the EIL allows operation of the electric traction motor to occur above default torque and speed operating limits for the full duration of the boosted driving maneuver.

10. The electrified powertrain of claim 9, wherein the controller is configured, in response to the current component capability not exceeding the calibrated capability threshold or the current use case not matching the predetermined approved use cases, to disable the EIL.

11. The electrified powertrain of claim 10, further comprising an accelerator pedal, wherein the input signals include an amount of pedal travel of the accelerator pedal, and the predetermined approved use case includes a wide-open throttle or wide-open pedal condition of the accelerator pedal corresponding to a predetermined acceleration event.

12. The electrified powertrain of claim 11, wherein the predetermined approved use case includes an acceleration-from-a-standstill maneuver and/or a high-speed passing maneuver indicative of the wide-open throttle or wide-open pedal condition.

13. The electrified powertrain of claim 9, wherein the controller is further configured to selectively disable the EIL in response to an active traction control state.

14. The electrified powertrain of claim 9, wherein the electrified powertrain is used as part of a motor vehicle, and wherein the indicator device is a digital gauge of the motor vehicle.

15. The electrified powertrain of claim 14, wherein the controller is configured to communicate the availability status of the MPM by illuminating one or more light-emitting diodes of the digital gauge with a color indicative of the availability status.

16. The electrified powertrain of claim 9, wherein the electric traction motor includes a plurality of electric traction motors, the TPIM includes a plurality of TPIMs each connected to a respective one of the electric traction motors, and the electrified powertrain includes a plurality of drive axles each coupled to a respective one of the electric traction motors, wherein the controller is configured to execute a costing function to allocate the desired torque to the drive axles during the MPM to thereby balance thermal loading and wear of the electric traction motors and the TPIMs.

17. A motor vehicle comprising:
a plurality of road wheels;
an accelerator pedal; and
an electrified powertrain having:
a high-voltage (HV) battery pack providing a direct current (DC) voltage;
a polyphase electric traction motor having a stator and a rotor, wherein the rotor is coupled to one or more of the road wheels;
a traction power inverter module (TPIM) electrically connected to the stator and to the HV battery pack, wherein the TPIM is configured to convert the DC voltage from the HV battery pack to an alternating current (AC) voltage, and to deliver the AC voltage to the stator; and
a controller configured to:
determine, using the input signals, a current component capability and a current use case of the electrified powertrain;
in response to the current component capability being less than a calibrated capability threshold and the current use case matching a predetermined approved use case, determine whether a predetermined margin exists in the current component capability for operating the electrified powertrain in a maximum performance mode (MPM) for a full duration of a boosted driving maneuver;
receive input signals indicative of a requested torque, the requested torque being a desired output torque level of the electric traction motor; and
in response to the input signals when the predetermined margin exists, temporarily apply an extended inverter limit (EIL) of the TPIM to thereby enable the MPM, wherein application of the EIL allows operation of the electric traction motor to occur above default torque and speed operating limits for the full duration of the boosted driving maneuver.

18. The motor vehicle of claim 17, wherein the controller is configured, in response to the current component capability not exceeding the calibrated capability threshold or the current use case not matching one of the approved use cases, to disable the EIL.

19. The motor vehicle of claim 17, wherein the indicator device is a digital gauge, and activating the indicator device includes displaying the availability status via the digital gauge.

20. The motor vehicle of claim 17, wherein the electric traction motor includes a plurality of electric traction motors, the TPIM includes a plurality of TPIMs each connected to a respective one of the electric traction motors, and the electrified powertrain includes a plurality of drive axles each coupled to a respective one of the electric traction motors, wherein the controller is configured to execute a costing function to allocate the desired torque to the drive axles during the MPM and thereby balance thermal loading and wear of the electric traction motors and the TPIMs.
